(19) United States
(12) Patent Application Publication
(10) Pub. No.: US 2016/0031066 A1
(43) Pub. Date: Feb. 4, 2016

(54) WRENCH WITH GRIP ENHANCING APPARATUS

(71) Applicant: Thru Tubing Solutions, Inc., Oklahoma City, OK (US)

(72) Inventors: Brock Watson, Oklahoma City, OK (US); Roger Schultz, Newcastle, OK (US)

(73) Assignee: Thru Tubing Solutions, Inc.

(21) Appl. No.: 14/880,849

(22) Filed: Oct. 12, 2015

Related U.S. Application Data
(62) Division of application No. 13/934,501, filed on Jul. 3, 2013.

(51) Int. Cl. B25B 13/50; B25B 13/20

(52) U.S. Cl. CPC B25B 13/5058; B25B 13/20

(57) ABSTRACT

This disclosure is related to an adjustable wrench for engaging work objects. The adjustable wrench has a handle having a handle end and a flat serrated jaw surface. The adjustable wrench also has an L-shaped movable jaw having a lever arm and a serrated jaw, the lever arm having a terminal end. The adjustable wrench further comprises a projection extending from the handle having a tunnel therein for accepting the lever arm of the L-shaped movable jaw and a grip enhancing apparatus.

### STATEMENT REGARDING FEDERALLY SPONSORED RESEARCH OR DEVELOPMENT

Not applicable.

### CROSS-REFERENCE TO RELATED APPLICATIONS

The present application is a divisional of U.S. patent application having U.S. Ser. No. 13/934,501, filed Jul. 3, 2013, which is conversion of U.S. Provisional application having U.S. Ser. No. 61/667,565, filed Jul. 3, 2012, which claims the benefit under 35 U.S.C. 119(e). The disclosure of which is hereby expressly incorporated herein by reference.

### BACKGROUND OF THE INVENTION

1. Field of the Invention

The present invention relates to a wrench that includes a grip enhancing apparatus to more efficiently engage a work object.

2. Description of the Related Art

Traditionally, pipe wrenches are adjustable wrenches used for fitting and turning rounded surfaces. A user manipulates the wrench to fit the rounded surface and then must apply pressure to the wrench to engage the rounded surface and turn it. If a user does not continue to apply force to the wrench, the wrench will not stay engaged on the rounded surface and would fall to the ground if the user does not hold it. Accordingly, there is a need for a wrench that can stay engaged on a rounded surface without the user having to hold the wrench and continually apply pressure to the wrench.

### SUMMARY OF THE INVENTION

The present disclosure is directed to an adjustable wrench for engaging a work object. The wrench includes an opening, a handle having a handle end and a flat serrated jaw surface. The wrench also includes an L-shaped movable jaw having a lever arm and a serrated jaw, the lever arm having a terminal end. The wrench further includes a projection extending from the handle having a tunnel therein for accepting the lever arm of the L-shaped movable jaw. Additionally, the wrench includes a grip enhancing apparatus. The grip enhancing apparatus includes a threaded nut element disposed adjacent to the lever arm, the threaded nut element having a threaded opening therein. The grip enhancing apparatus also includes a threaded shaft for extending through the opening of the handle and engaging the threaded opening of the threaded nut element. The threaded shaft can extend through the threaded nut element and contact the lever arm of the adjustable wrench, forcing the L-shaped movable jaw away from the handle and the serrated jaw of the L-shaped movable jaw is forced toward the flat serrated jaw surface.

The present disclosure is related to another adjustable wrench. The adjustable wrench includes a handle having a handle end and a flat serrated jaw surface, a projection extending from the handle having a tunnel therein for accepting the lever arm of the L-shaped movable jaw, and a grip enhancing apparatus. The grip enhancing apparatus having a cam device supported by the lever arm, the cam device having an outer perimeter wherein a portion of the outer perimeter is defined by an increased radius of the cam device.

The present disclosure is related to another embodiment of an adjustable wrench. The adjustable wrench includes a handle having a handle end and a flat serrated jaw surface, a projection extending from the handle having a tunnel therein for accepting the lever arm of the L-shaped movable jaw, and a grip enhancing apparatus. The grip enhancing apparatus having a wedge device slidably disposed on the handle, wherein the wedge device can slide between the lever arm and the handle. The grip enhancing apparatus also includes a protrusion extending from the handle having a threaded passageway therein. The grip enhancing apparatus further includes a rod with a threaded portion for engaging the threaded passageway of the protrusion.

The present disclosure is related to yet another embodiment of an adjustable wrench. The adjustable wrench includes a handle having a handle end and a flat serrated jaw surface, a projection extending from the handle having a tunnel therein for accepting the lever arm of the L-shaped movable jaw, and a grip enhancing apparatus. The grip enhancing apparatus having a tubular element to frictionally engage at least the lever arm and force the lever arm away from the handle.

The present disclosure is also related to a grip enhancing apparatus for use with an adjustable wrench. The grip enhancing apparatus includes a wedge element partially disposable between the handle of the wrench and the lever arm, the wedge element having a threaded passageway therein. The grip enhancing apparatus also includes a rod with a threaded portion for engaging the threaded passageway of the wedge element.

### BRIEF DESCRIPTION OF THE DRAWINGS

FIG. 1 is a perspective view of an adjustable wrench with grip enhancing apparatus constructed in accordance with the present disclosure.

FIG. 2 is a cross-sectional view of another embodiment of the adjustable wrench with grip enhancing apparatus constructed in accordance with the present disclosure.

FIG. 3 is a perspective view of another embodiment of the adjustable wrench with grip enhancing apparatus constructed in accordance with the present disclosure.

FIG. 4 is a cross-sectional view of another embodiment of the adjustable wrench with grip enhancing apparatus constructed in accordance with the present disclosure.

FIG. 5 is a perspective view of another embodiment of the adjustable wrench with grip enhancing apparatus constructed in accordance with the present disclosure.

FIG. 6 is a cross-sectional view of another embodiment of the adjustable wrench with grip enhancing apparatus constructed in accordance with the present disclosure.

FIG. 7 is a perspective view of another embodiment of the adjustable wrench with grip enhancing apparatus constructed in accordance with the present disclosure.

FIG. 8 is a perspective view of another embodiment of the adjustable wrench with grip enhancing apparatus constructed in accordance with the present disclosure.

FIG. 9 is a perspective view of another embodiment of the adjustable wrench with grip enhancing apparatus constructed in accordance with the present disclosure.

FIG. 10 is a perspective view of another embodiment of the adjustable wrench with grip enhancing apparatus constructed in accordance with the present disclosure.

FIG. 11 is a perspective view of another embodiment of the adjustable wrench with grip enhancing apparatus constructed in accordance with the present disclosure.

FIG. 12 is a perspective view of another embodiment of the adjustable wrench with grip enhancing apparatus constructed in accordance with the present disclosure.

FIG. 13 is a perspective view of another embodiment of the adjustable wrench with grip enhancing apparatus constructed in accordance with the present disclosure.

### DETAILED DESCRIPTION OF THE INVENTION

The present disclosure relates to an adjustable wrench 110 that includes a grip enhancing apparatus 112 to more efficiently engage a work object 114. The work object 114 can be anything capable of having the adjustable wrench 110 used thereon. In one embodiment, the adjustable wrench 110 can be any type of pipe wrench known in the art.

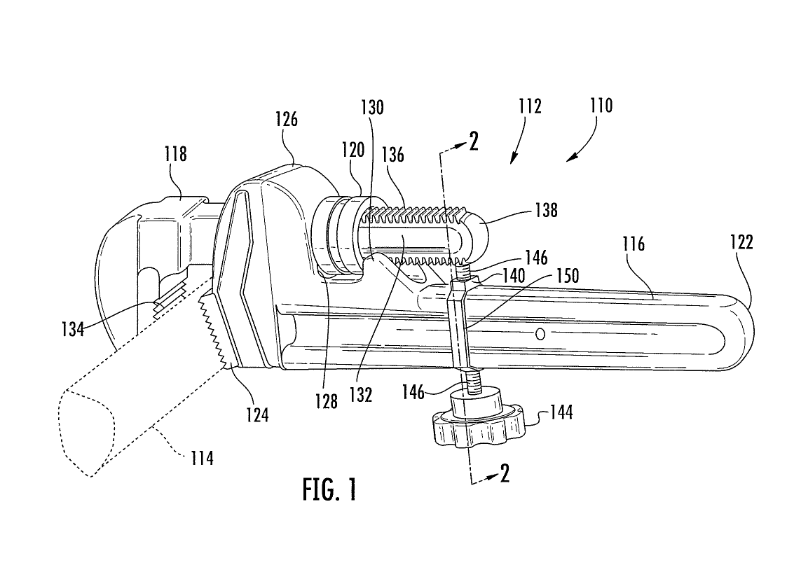

As shown in FIG. 1, an adjustable wrench 110 can include a handle 116, an L-shaped movable jaw 118 and an adjustment nut 120 for positioning the L-shaped movable jaw 118 (or hook jaw) respective of the handle 116. The handle 116 has a handle end 122, a flat serrated jaw surface 124 for engaging the work object 114, and a first projection 126 disposed on the handle 116 adjacent to the flat serrated jaw surface 124. The first projection 126 includes an adaptively-sized tunnel 128 disposed therethrough. The handle 116 can also include a second projection 130 disposed on the handle 116 that cooperates with the first projection 126 to hold and maintain the adjustment nut 120 therebetween.

The L-shaped movable jaw 118 has a lever arm 132 and a serrated jaw 134 for further engagement of the work object 114. The lever arm 132 includes threads 136 that engage the adjustment nut 120 and a terminal end 138 disposed at the opposite end of the L-shaped movable jaw 118 from the serrated jaw 134. Furthermore, the lever arm 132 of the L-shaped movable jaw 118 can be positioned within the tunnel 128 of the first projection 126 of the handle 116. The second projection 130 of the handle 116 is sized such that it does not interfere with the lever arm 132 of the L-shaped movable jaw 118 as it extends through the tunnel 128.

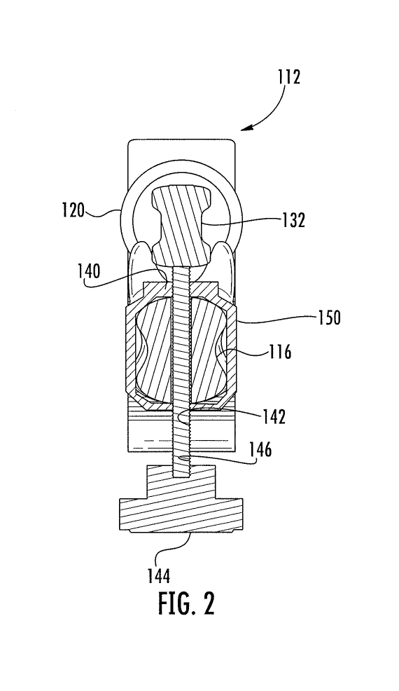

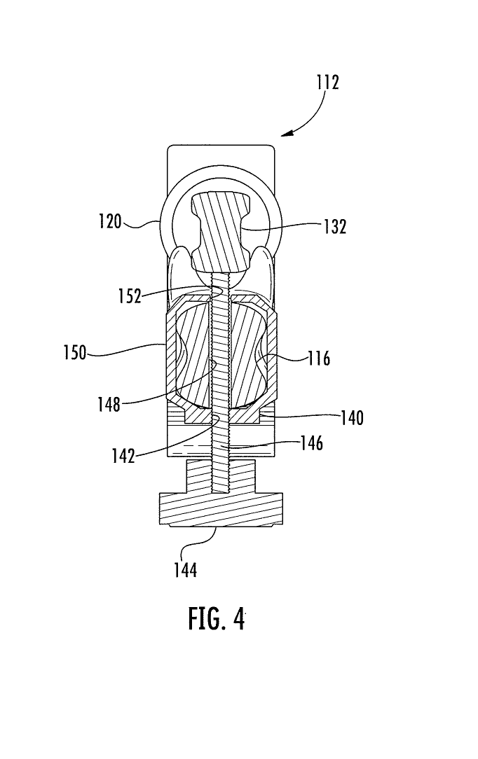

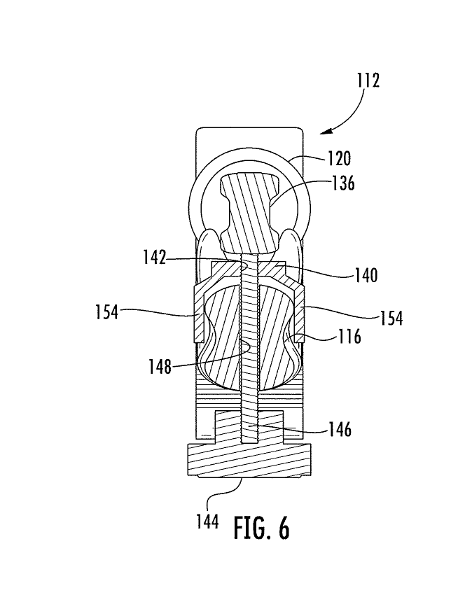

In various embodiments, shown in FIGS. 1-7, the adjustable wrench 110 can also include the grip enhancing apparatus 112. In these embodiments, the grip enhancing apparatus 112 includes a threaded nut element 140, a threaded opening 142 disposed in a portion of the threaded nut element 140, and a threaded shaft 146 to engage the threaded opening 142 of the threaded nut element 140. In another embodiment of the present disclosure, the grip enhancing apparatus 112 can include a turn handle 144 attachable to the threaded shaft 146 or, in certain embodiments, the threaded nut element 140. It should be understood that the turn handle 144 can be positioned anywhere on the threaded shaft 146 relative to the handle 116 and lever arm 132, and the turn handle 144 can be any apparatus capable of being grasped by a user and turned. In these embodiments, the handle 116 has a passageway 148 disposed therein, generally in alignment with at least a portion of the lever arm 132, whereby the threaded shaft 146 of the grip enhancing apparatus 112 can extend therethrough.

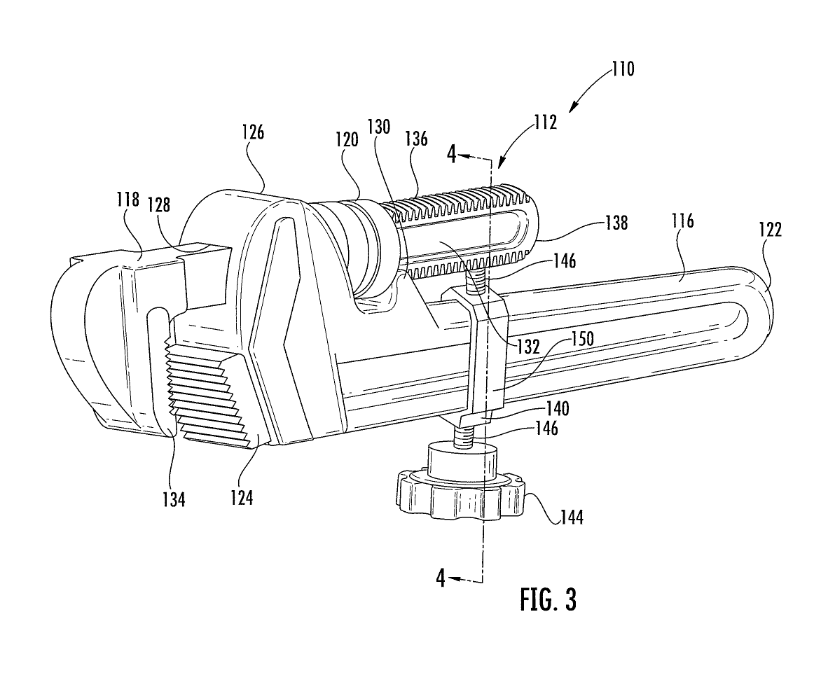

The threaded nut element 140 of the present disclosure can take on a number of shapes and sizes. In two embodiments, shown in FIGS. 1 and 3, the threaded nut element 140 includes a ring portion 150 attached thereto that extends around the handle 116 to prevent the threaded nut element 140 from turning as the turn handle 144 turns the threaded shaft 146. The ring portion 150 of the threaded nut element 140 includes an opening 152 for permitting the threaded shaft 146 to extend therethrough and generally align with the threaded opening 142 of the threaded nut element 140. In one embodiment, shown in FIG. 1, the threaded opening 142 of the threaded nut element 140 is disposed between the terminal end 138 of the lever arm 132 and the handle 116 of the adjustable wrench 110. In another embodiment, shown in FIG. 3, the threaded opening 142 of the threaded nut element 140 is disposed on the opposite side of handle 116 from the lever arm 132.

In use, the threaded shaft 146 of the grip enhancing apparatus 112 extends through the passageway 148 in the handle 116 of the adjustable wrench 110 and the opening 152 in the ring portion 150 of the threaded nut element 140 and engages the threaded opening 142 of the threaded nut element 140. The ring portion 150 of the threaded nut element 140 may contact the handle 116 of the adjustable wrench 110 and prevent the threaded nut element 140 from turning when the threaded opening 142 of the threaded nut element 140 is being engaged by the threaded shaft 146. As the threaded shaft 146 continues to engage the threaded nut element 140, the threaded shaft 146 ultimately contacts the lever arm 132. As the turn handle 144 of the grip enhancing apparatus 112 is turned and continues to force the threaded shaft 146 to engage the lever arm 132, the lever arm 132 of the L-shaped movable jaw 118 is forced away from the handle 116 and the serrated jaw 134 of the L-shaped movable jaw 118 is forced toward the flat serrated jaw surface 124 of the handle 116. At a certain point, the work object 114 is securely engaged by the serrated jaw 134 of the L-shaped movable jaw 118 and the flat serrated jaw surface 124 of the handle 116 and the wrench 110 can remain engaged on the work object 114 without a user having to maintain any pressure on the wrench 110 or hold the wrench 110.

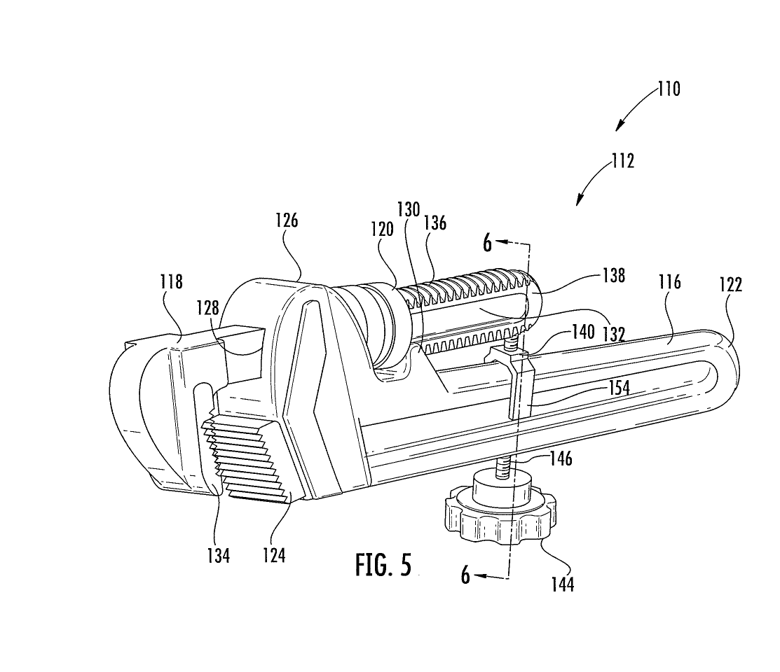

In another embodiment, shown in FIG. 5, the threaded nut element 140 includes at least one wing element 154 attached thereto that extends away from the threaded nut element 140 and adjacent to the handle 116 to prevent the threaded nut element 140 from turning as the turn handle 144 turns the threaded shaft 146. In another embodiment, the threaded nut element 140 includes two wing elements 154 extending away from the threaded nut element 140, each wing element 154 disposed adjacent to the handle 116 of the adjustable wrench 110 to prevent the threaded nut element 140 from turning as the turn handle 144 turns the threaded shaft 146. In one embodiment, the threaded opening 142 of the threaded nut element 140 is disposed between the terminal end 138 of the lever arm 132 and the handle 116 of the adjustable wrench 110. In another embodiment, the two wing elements 154 extend away from the threaded nut element 140 and are disposed adjacent to the lever arm 132 to prevent the threaded nut element 140 from turning as the turn handle 144 turns the threaded shaft 146.

In use, the threaded shaft 146 of the grip enhancing apparatus 112 extends through the passageway 148 in the handle 116 of the adjustable wrench 110 and engages the threaded opening 142 of the threaded nut element 140. The at least one wing element 154 of the threaded nut element 140 may contact the lever arm 132 or the handle 116 and prevent the threaded nut element 140 from turning when the threaded opening 142 of the threaded nut element 140 is being engaged by the threaded shaft 146. As the threaded shaft 146 continues to engage the threaded nut element 140, the threaded shaft 146 ultimately contacts the lever arm 132. As the turn handle 144 of the grip enhancing apparatus 112 is turned and continues to force the threaded shaft 146 to engage the lever arm 132, the lever arm 132 of the L-shaped movable jaw 118 is forced away from the handle 116 and the serrated jaw 134 of the L-shaped movable jaw 118 is forced toward the flat serrated jaw surface 124 of the handle 116. At a certain point, the work object 114 is securely engaged by the serrated jaw 134 of the L-shaped movable jaw 118 and the flat serrated jaw surface 124 of the handle 116 and the wrench 110 can remain engaged on the work object 114 without a user having to maintain any pressure on the wrench 110 or hold the wrench 110.

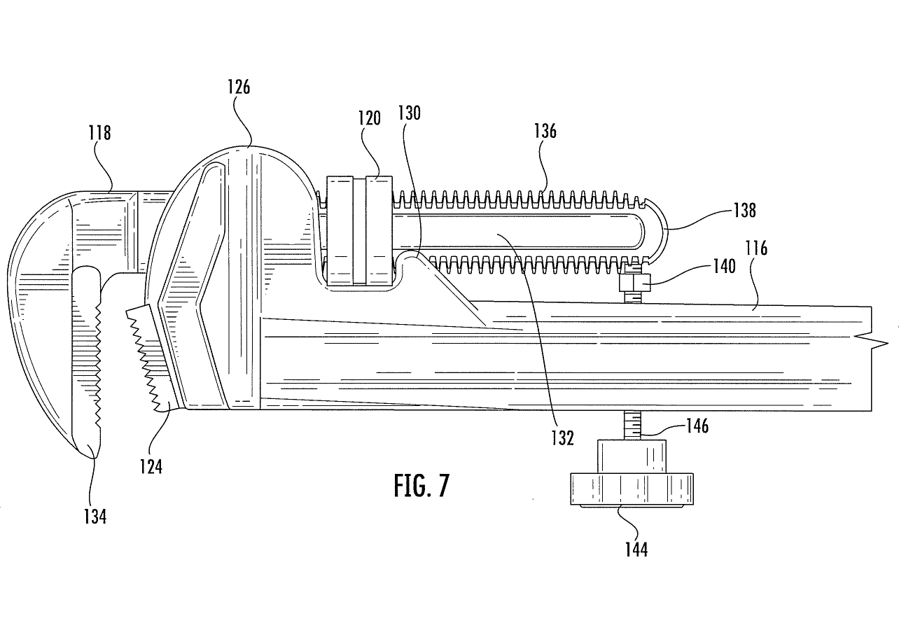

In yet another embodiment, shown in FIG. 7, the threaded nut element 140 is a nut, or a hexagonal nut. The threaded nut element 140 permits the threaded shaft 146 to extend therethrough. The threaded nut element 140 can be disposed between the terminal end 138 of the lever arm 132 and the handle 116 of the adjustable wrench 110. In another embodiment, the turn handle 144 can be attached to the threaded nut 140.

In use, the threaded shaft 146 of the grip enhancing apparatus 112 extends through the passageway 148 in the handle 116 of the adjustable wrench 110 and engages the threaded nut element 140. As the threaded shaft 146 continues to engage the threaded nut element 140, the threaded shaft 146 ultimately contacts the lever arm 132. As the turn handle 144 of the grip enhancing apparatus 112 is turned and continues to force the threaded shaft 146 to engage the lever arm 132, the lever arm 132 of the L-shaped movable jaw 118 is forced away from the handle 116 and the serrated jaw 134 of the L-shaped movable jaw 118 is forced toward the flat serrated jaw surface 124 of the handle 116. At a certain point, the work object 114 is securely engaged by the serrated jaw 134 of the L-shaped movable jaw 118 and the flat serrated jaw surface 124 of the handle 116 and the wrench 110 can remain engaged on the work object 114 without a user having to maintain any pressure on the wrench 110 or hold the wrench 110.

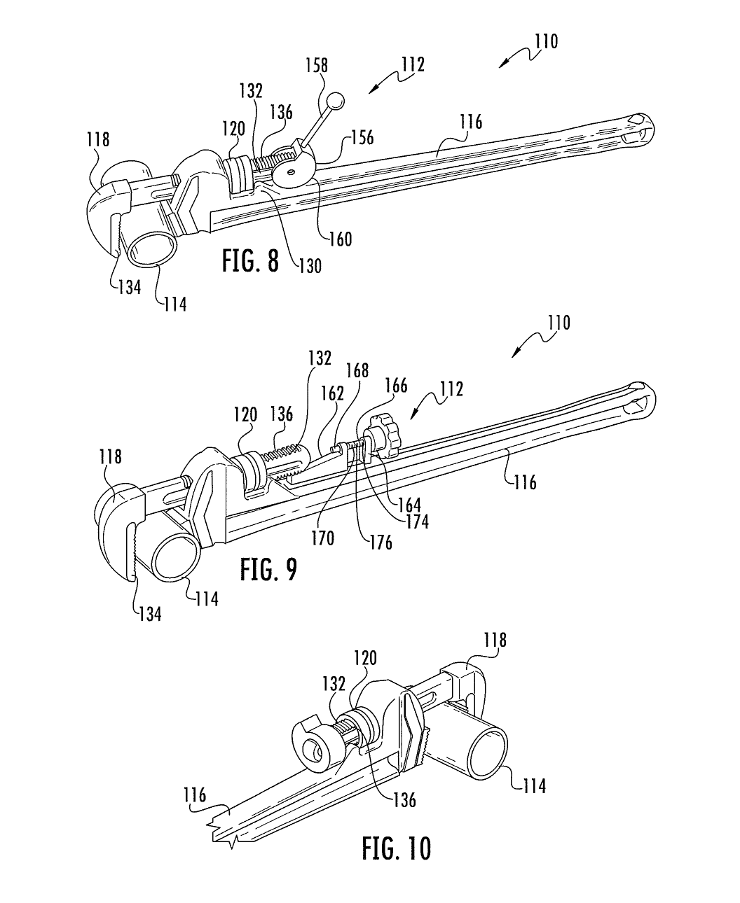

In yet another embodiment of the present disclosure, shown in FIG. 8, the grip enhancing apparatus 112 includes a cam device 156 rotatably supported by the lever arm 132 of the L-shaped movable jaw 118. In this embodiment, the cam device 156 is rotated in a direction that is substantially parallel with the handle 116 of the adjustable wrench 110. The grip enhancing apparatus 112 of this embodiment further includes a leverage element 158 (or any type of handle capable of being attached to the cam device 156 and rotating the cam device 156) attached to the cam device 156 to turn the cam device 156 about the lever arm 132. In this embodiment, the cam device 156 has a radius that increases over a portion of an outside perimeter 160 of the cam device 156.

In use, the lever arm 132 of the L-shaped movable jaw 118 is forced away from the handle 116 when the leverage element 158 rotates the cam device 156 such that the increased radius is positioned between the lever arm 132 and the handle 116. As the leverage element 158 of the grip enhancing apparatus 112 is turned and forces the cam device 156 to engage the lever arm 132, the lever arm 132 of the L-shaped movable jaw 118 is forced away from the handle 116 and the serrated jaw 134 of the L-shaped movable jaw 118 is forced toward the flat serrated jaw surface 124 of the handle 116. At a certain point, the work object 114 is securely engaged by the serrated jaw 134 of the L-shaped movable jaw 118 and the flat serrated jaw surface 124 of the handle 116 and the wrench 110 can remain engaged on the work object 114 without a user having to maintain any pressure on the wrench 110 or hold the wrench 110.

In yet another embodiment of the present disclosure shown in FIG. 9, the grip enhancing apparatus 112 includes a wedge device 162 slidably disposed on the handle 116 of the adjustable wrench 110 and under the lever arm 132 of the L-shaped movable jaw 118. In this embodiment, the grip enhancing apparatus 112 also includes a protrusion 164 extending from the handle 116 having a threaded passageway 166 disposed therein. In this embodiment, the wedge device 162 is attached to a first end 168 of a rod 170. In one embodiment, the rod 170 has a turn handle 172 attached to a second end 174 of the rod 170 and a threaded portion 176 for threadably engaging the threaded passageway 166 disposed in the protrusion 164 on the wrench handle 116. It should be understood that the wedge device 162 is not required to be attached to the rod 170. The wedge device 162 could be designed such that the rod 170 contacts it and just pushes the wedge device 162 into the desired position to make the grip enhancing apparatus 112 work properly with the adjustable wrench 110.

In use, the rod 170 is turned and the threaded portion 176 of the rod 170 engages the threaded passageway 166 disposed in the protrusion 164 of the wrench handle 116, the wedge device 162 slides toward the serrated jaw 134 of the L-shaped movable jaw 118 and forces the lever arm 132 of the L-shaped movable jaw 118 away from the handle 116 of the adjustable wrench 110. At a certain point, the work object 114 is securely engaged by the serrated jaw 134 of the L-shaped movable jaw 118 and the flat serrated jaw surface 124 of the handle 116 and the wrench 110 can remain engaged on the work object 114 without a user having to maintain any pressure on the wrench 110 or hold the wrench 110.

In another embodiment shown, FIG. 10, the grip enhancing apparatus 112 includes a cam device 178 that has an increased radius over a portion of the perimeter of the cam device 178 and turns about the lever arm 132 in a direction that is substantially perpendicular to the length of the handle 116 of the adjustable wrench 110. The cam device 178 in this embodiment is supported by the lever arm 132 of the L-shaped movable jaw 118 and can be rotated around the threads 136 of the lever arm 132.

In use, the lever arm 132 of the L-shaped movable jaw 118 is forced away from the handle 116 when the cam device 178 is rotated such that the increased radius portion of the cam device 178 is positioned between the lever arm 132 and the handle 116. As the cam device 178 is turned, the increased radius of the cam device 178 forces the cam device 178 to engage the handle 116. This forces the lever arm 132 of the L-shaped movable jaw 118 away from the handle 116 and the serrated jaw 134 of the L-shaped movable jaw 118 is forced toward the flat serrated jaw surface 124 of the handle 116. At a certain point, the work object 114 is securely engaged by the serrated jaw 134 of the L-shaped movable jaw 118 and the flat serrated jaw surface 124 of the handle 116 and the wrench 110 can remain engaged on the work object 114 without a user having to maintain any pressure on the wrench 110 or hold the wrench 110.

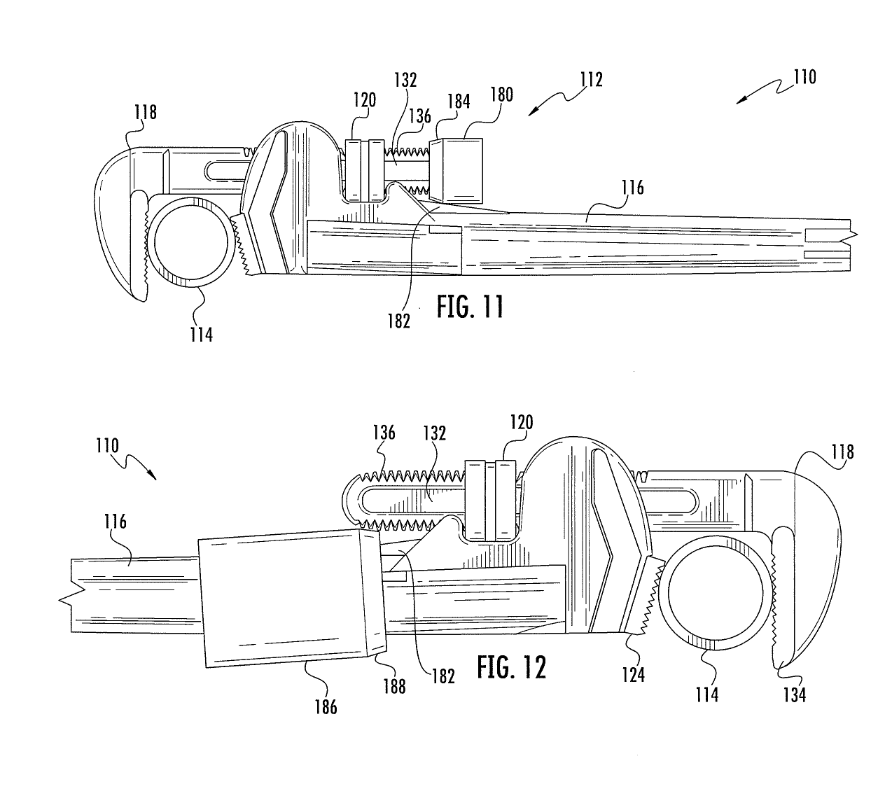

In yet another embodiment of the present disclosure, shown in FIG. 11, the grip enhancing apparatus 112 includes a tubular element 180 sized such that it can be disposed around the lever arm 132 of the L-shaped movable jaw 118. In this embodiment, the handle 116 of the adjustable wrench 110 includes an inclined portion 182 attached to the handle 116 between the lever arm 132 and the handle 116. The inclined portion 182 inclines in the direction from the handle end 122 to the flat serrated jaw surface 124. In another embodiment, the tubular element 180 includes a tapered portion 184 disposed about at least a portion of the circumference of one end of the tubular element 180.

In use, the tubular element 180 can be forced by hand over the lever arm 132 to frictionally engage with at least the inclined portion 182 of the handle 116 and/or the lever arm 132. This would force the lever arm 132 of the L-shaped movable jaw 118 to be forced away from the handle 116 of the adjustable wrench 110, which would force the serrated jaw 134 of the L-shaped movable jaw 118 toward the flat serrated jaw surface 124 of the handle 116. This enables the adjustable wrench 110 to grip a work object 114 without a user having to continually apply force to the adjustable wrench 110 or hold the adjustable wrench 110 in place. In another embodiment, the terminal end 138 of the lever arm 132 is threaded and the tubular element 180 is threaded. In this embodiment, the user would screw the tubular element 180 in place such that the tapered portion 184 engages the inclined portion 182 of the wrench handle 116, as described above.

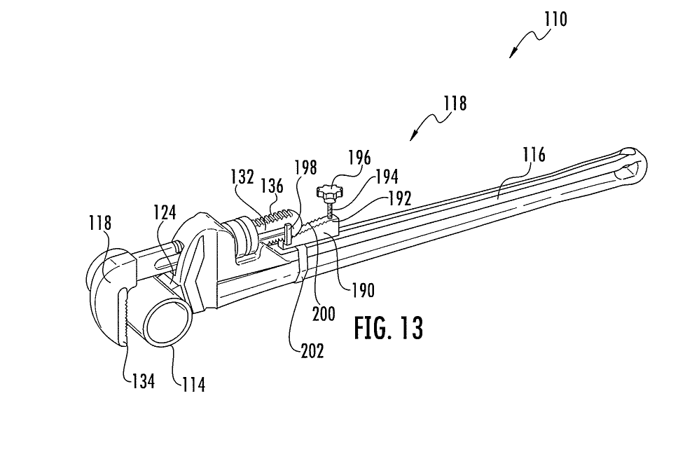

In yet another embodiment, shown in FIG. 12, the grip enhancing apparatus 112 includes a tubular element 186 sized such that it can be disposed around the handle 116 of the adjustable wrench 110. In this embodiment, the handle 116 of the adjustable wrench 110 includes the inclined portion 182 attached to the handle 116 between the lever arm 132 and the handle 116. The inclined portion 182 inclines in the direction from the handle end 122 to the flat serrated jaw surface 124. In another embodiment, the tubular element 186 includes a tapered portion 188 disposed about at least a portion of the circumference of one end of the tubular element 186.

In use, the tubular element 186 can be forced by hand over the handle 116 to frictionally engage with at least the inclined portion 182 of the handle 116 and/or the lever arm 132. This would force the lever arm 132 of the L-shaped movable jaw 118 to be forced away from the handle 116 of the adjustable wrench 110, which would force the serrated jaw 134 of the L-shaped movable jaw 118 toward the flat serrated jaw surface 124 of the handle 116. This enables the adjustable wrench 110 to grip a work object 114 without a user having to continually apply force to the adjustable wrench 110, or hold the adjustable wrench 110 in place.

In another embodiment of the present disclosure shown in FIG. 13, the grip enhancing apparatus 112 includes a wedge element 190 disposable on the handle 116 of the adjustable wrench 110 and under the lever arm 132 of the L-shaped movable jaw 118. In this embodiment, the wedge element 190 also includes a threaded passageway 192 disposed therein. In this embodiment, the grip enhancing apparatus 112 also includes an at least partially threaded rod 194 to engage the threaded passageway 192 disposed in the wedge element 190. In one embodiment, the rod 170 has a turn handle 196 attached thereto. In another embodiment, the wedge element 190 can include a plurality of wing elements 198 that extend from the wedge element 190 and are disposed adjacent to the lever arm 32 and/or the handle 116 of the adjustable wrench 110 to prevent the wedge element 190 from turning when the rod 194 is turned. In a further embodiment, the wedge element 190 can include at least one ridge element 200 disposed on a top portion of the wedge element 190 to engage with the threads 136 of the lever arm 132. The at least one ridge element 200 prevents the wedge element 190 from sliding back when in use.

In another embodiment, the grip enhancing apparatus 112 can include an attachment apparatus 202 for selectively attaching the wedge element 190 to the handle 116 or the lever arm 132. Examples include, but are not limited to Velcro, elastic strap, and the like. It should be understood that the attachment apparatus 202 can be any device known in the art capable of securing the attachment apparatus 202 to the handle 116 or lever arm 132 and permits the grip enhancing apparatus 112 to perform its intended function.

In use, the grip enhancing apparatus 112 is placed in the appropriate position relative to the lever arm 132 and the handle 116. The threaded rod 194 is then turned and engages the threaded passageway 192 disposed in the wedge element 190. As the rod 194 is turned through the threaded passageway 192, the rod 194 will ultimately contact the handle 116, which raises the wedge element 190 off of the handle 116 and forces the wedge element 190 into the lever arm 132. This forces the lever arm 132 of the L-shaped movable jaw 118 away from the handle 116 of the adjustable wrench 110. At a certain point, the work object 114 is securely engaged by the serrated jaw 134 of the L-shaped movable jaw 118 and the flat serrated jaw surface 124 of the handle 116 and the wrench 110 can remain engaged on the work object 114 without a user having to maintain any pressure on the wrench 110 or hold the wrench 110.

From the above description, it is clear that the present disclosure is well adapted to carry out the objectives and to attain the advantages mentioned herein as well as those inherent in the disclosure. While presently preferred embodiments of the disclosure have been described, it will be understood that numerous changes may be made which will readily suggest themselves to those skilled in the art and which are accomplished within the spirit of the disclosure and claims herein.

What is claimed is:

1. An adjustable wrench for engaging a work object, the wrench comprising:
a handle having a handle end and a flat serrated jaw surface;
an L-shaped movable jaw having a lever arm and a serrated jaw, the lever arm having a terminal end;
a projection extending from the handle having a tunnel therein for accepting the lever arm of the L-shaped movable jaw; and
a grip enhancing apparatus, the grip enhancing apparatus comprising:
a cam device supported by the lever arm, the cam device having an outer perimeter wherein a portion of the outer perimeter is defined by an increased radius of the cam device.

2. The wrench of claim 1 wherein the cam device rotates in a direction that is substantially parallel with the handle.

3. The wrench of claim 1 wherein the cam device rotates in a direction that is substantially perpendicular to the length of the handle.

4. The wrench of claim 1 wherein the radius of the cam device gradually increases over a portion of the outer perimeter of the cam device.

5. The wrench of claim 1 wherein the grip enhancing apparatus further includes a leverage element attached to the cam device.

6. An adjustable wrench for engaging a work object, the wrench comprising:
a handle having a handle end and a flat serrated jaw surface;
an L-shaped movable jaw having a lever arm and a serrated jaw, the lever arm having a terminal end;
a projection extending from the handle having a tunnel therein for accepting the lever arm of the L-shaped movable jaw; and
a grip enhancing apparatus, the grip enhancing apparatus comprising:
a wedge device slidably disposed on the handle, wherein the wedge device can slide between the lever arm and the handle;
a protrusion extending from the handle having a threaded passageway therein; and
a rod with a threaded portion for engaging the threaded passageway of the protrusion.

7. The wrench of claim 6 wherein the wedge device is attached to one end of the rod.

8. The wrench of claim 7 wherein a turn handle is attached to the rod.

9. An adjustable wrench for engaging a work object, the wrench comprising:
a handle having a handle end and a flat serrated jaw surface;
an L-shaped movable jaw having a lever arm and a serrated jaw, the lever arm having a terminal end;
a projection extending from the handle having a tunnel therein for accepting the lever arm of the L-shaped movable jaw; and
a grip enhancing apparatus, the grip enhancing apparatus comprising:
a tubular element to frictionally engage at least the lever arm and force the lever arm away from the handle.

10. The wrench of claim 9 wherein the handle has an inclined portion opposite of the lever arm.

11. The wrench of claim 9 wherein the tubular element has a tapered portion disposed about at least a portion of a circumference of one end of the tubular element.

12. The wrench of claim 9 wherein the tubular element is sized to fit over the lever arm.

13. The wrench of claim 9 wherein the tubular element is sized to fit over the handle.

14. An adjustable wrench for engaging a work object, the wrench comprising:
a handle having a handle end and a flat serrated jaw surface;
an L-shaped movable jaw having a lever arm and a serrated jaw, the lever arm having threads and a terminal end;
a projection extending from the handle having a tunnel therein for accepting the lever arm of the L-shaped movable jaw; and
a grip enhancing apparatus, the grip enhancing apparatus comprising:
a wedge element at least partially disposable between the handle and the lever arm, the wedge element having a threaded passageway therein; and
a rod with a threaded portion for engaging the threaded passageway of the wedge element.

15. The wrench of claim 14 wherein the wedge element has at least one wing element attached thereto which extends away from the wedge element and is positioned adjacent to the lever arm or the wrench handle.

16. The wrench of claim 14 wherein the wedge element has a plurality of wing elements attached thereto which extend away from the wedge element and are positioned adjacent to the lever arm or the wrench handle.

17. The wrench of claim 14 wherein the wedge element includes at least one ridge element to engage the threads of the lever arm.

18. The wrench of claim 14 wherein the grip enhancing apparatus further includes an attachment apparatus to selectively attach the wedge element to the handle or lever arm.

19. The wrench of claim 14 wherein the rod has a turn handle attached thereto.

20. A grip enhancing apparatus for an adjustable wrench to facilitate the engagement of a work object, the adjustable wrench having a handle, a flat serrated jaw surface, and an L-shaped movable jaw having a lever arm and a serrated jaw, the the grip enhancing apparatus comprising:
a wedge element partially disposable between the handle of the wrench and the lever arm, the wedge element having a threaded passageway therein; and
a rod with a threaded portion for engaging the threaded passageway of the wedge element.

21. The apparatus of claim 20 wherein the wedge element has at least one wing element attached thereto which extends away from the wedge element and is positioned adjacent to the lever arm or the wrench handle.

22. The apparatus of claim 20 wherein the wedge element has a plurality of wing elements attached thereto which extend away from the wedge element and are positioned adjacent to the lever arm or the wrench handle.

23. The apparatus of claim 20 wherein the wedge element includes at least one ridge element to engage the threads of the lever arm.

24. The apparatus of claim 20 wherein the grip enhancing apparatus further includes an attachment apparatus to selectively attach the wedge element to the handle or lever arm.

25. The apparatus of claim 20 wherein the rod has a turn handle attached thereto.
